(19) United States
(12) Patent Application Publication
(10) Pub. No.: US 2022/0204322 A1
(43) Pub. Date: Jun. 30, 2022

(54) LIFTING DEVICE AND LIFTING PLATFORM FOR LIFTING AND LOWERING VEHICLES OR LOADS

(71) Applicant: Gerhard FINKBEINER, Freudenstadt (DE)

(72) Inventor: Gerhard FINKBEINER, Freudenstadt (DE)

(21) Appl. No.: 17/564,483

(22) Filed: Dec. 29, 2021

(30) Foreign Application Priority Data
Dec. 30, 2020 (DE) 10 2020 135 143.7

(51) Int. Cl. B66F 3/46

(52) U.S. Cl. CPC B66F 3/46

(57) ABSTRACT

A lifting device and to a lifting platform for lifting and lowering vehicles or loads, with a base body and with a support moveable up and down relative to the base body, with a drive device for lifting and lowering the support, wherein a guide is provided on the support, which guide is fixedly connected to the support, and the guide has at least one support arm which is mounted at least on one side so as to be extendable in the horizontal direction through the guide.

The invention relates to a lifting device for lifting and lowering vehicles or loads and to a lifting platform consisting of such lifting devices.

WO 2020/230079 A1 discloses a two-column lifting platform, which is constructed from two lifting devices lying opposite each other. These lifting devices comprise a base body on which a support is guided so as to be moveable up and down. Each support receives an articulated arm via a first joint, which articulated arm comprises a further joint at its free end. A retaining tube is pivotably provided on this joint and receives a support arm in each end portion in an extendable manner. The lifting columns are oriented at an angle deviating from 90° to the direction of travel of a vehicle when it is moved in between the two lifting columns.

DE 10 2018 105 573 A1 also discloses a two-column lifting platform. This two-column lifting platform comprises two lifting columns arranged opposite each other, in which a support is moveable up and down in the vertical direction along a lifting axis. A short support arm with a load receptacle is articulated to the support and a long support arm with a load receptacle is articulated to the support. The long support arm comprises a joint and an extendable support arm portion.

DE 20 2013 102 803 U1 also discloses a two-column lifting platform. This lifting platform comprises two lifting devices opposite each other. The lifting columns are fixed to the ground. A support is moveable up and down in a vertical direction. The support comprises a housing portion, to the outer ends of which support arms are attached in an articulated manner. These support arms can be telescopic and accommodate load-bearing elements at their outer ends.

A lifting platform is known from DE 10 2015 113 253 A1 in which two lifting devices are provided which are assigned to each other in pairs. The lifting devices are rotated with respect to the receiving space as seen in the direction of entry of a vehicle. A plate-like load receptacle is provided on each support and has a drive-on region, a supporting region and a drive-off region. The vehicle is positioned with its wheels on the various supporting regions in order to then lift and lower the vehicle.

The object of the invention is to propose a lifting device and a lifting platform for lifting and lowering vehicles or loads which has a simple structure and a high degree of flexibility in use.

This object is solved by a lifting device which has a support which is moveable up and down, which is guided by a base body and comprises a guide which is fixedly connected to the support and which accommodates at least one support arm which is mounted so that it can be extended at least on one side in the horizontal direction by the guide. This arrangement enables an increased load-bearing capacity due to the fixed arrangement of the guide on the support. Furthermore, the design of the guide on the support with the at least one horizontally extendable support arm has the advantage that this lifting device can also be easily adapted to vehicles with a large wheelbase.

According to a preferred embodiment of the lifting device, the at least one support arm is mounted in the guide, and the guide has at least one hollow profile body in which the at least one support arm is guided. This enables a structurally simple design, which at the same time has a high load-bearing capacity.

A preferred embodiment of the lifting device provides that the at least one support arm and the at least one hollow profile body have geometries which are matched to one another that form an anti-rotation means. Preferably, the hollow profile body and the support arm are polygonal or oval or have an asymmetrical cross-section. In this way, an anti-rotation means can be formed in a simple manner. Preferably, the hollow profile body and the profile of the support arms are rectangular.

According to a further preferred embodiment, the at least one support arm is secured in position for guidance by a releasable connecting element. For example, a plug-in bolt or a latching element can be provided. This enables easy adjustment and adaptation of the extended or retracted position of the at least one support arm for guiding. This allows different load points to be adjusted in a simple manner.

Advantageously, the guide accommodates two support arms arranged adjacent to each other, which are provided separately from each other in each case in a hollow profile body of the guide and are preferably accommodated by two hollow body profiles lying in one plane. In this way, a space-saving arrangement can be created, which furthermore enables the design of a large working region between two opposing lifting devices forming a lifting platform.

According to an alternative embodiment, the guide has a single hollow profile body in which two support arms are mounted so as to be extendable, in particular extendable in opposite directions, the support arms being mounted in a line one behind the other or in a manner engaging in one another or in parallel next to each other in the hollow profile body.

In particular, the support arms are mounted in the guide so that they can be extended in opposite directions to each other. This allows the lifting device to be individually adapted to the axle spacing of the particular vehicle to be lifted.

According to a first embodiment, the support arms are extendable synchronously. This allows evenly distributed load conditions to act on the support arms, so that a tilting moment acting on the support and thus on the base body is reduced or eliminated. Alternatively, the support arms on the guide can be extendable independently of each other. This has the advantage that, for example, in the case of vehicles whose load distribution over the respective axles is different, an asymmetrical arrangement of the load-bearing elements in relation to the support or base body is made possible, in order to reduce or avoid any tilting moments that may occur.

The length of each hollow profile body of the guide is preferably the same, and preferably their end portions are aligned with each other. This allows the support arms to be arranged in a first position relative to each other, so that there is a small distance between the various end portions of the support arms, in order to then engage with a wheel, for example, by means of the load receptacle. The support arms can then protrude from the guide on both sides. In a second position, the support arms can be extended in the opposite direction to take up a maximum distance between the various end portions, at which load-bearing means are preferably provided.

According to a further preferred embodiment, a drive is provided on the guide which controls an extension movement of the at least one support arm. This enables, for example, a controlled or automated adjustment of the position of the at least one support arm in relation to the support of the lifting device by means of a control system of the lifting device. For example, axle distances of vehicles can be stored in the control system so that when a specific vehicle is called up, the support arms can be automatically transferred to their position of use.

A further preferred design of the lifting device provides that the support arms can be extended individually by the drive. This means that an individual extension movement of each support arm can be controlled for guidance. Alternatively, one of the two support arms can be controlled by the drive and the other support arm can be positively controlled by a gear or a coupling mechanism.

According to an advantageous embodiment of the lifting device, at least one load-bearing means is provided or can be coupled to at least one support arm, in particular to the extendable end portion of the support arm or arms. In the case of a fixed connection of the load-bearing means, such as in the case of a welded connection, the lifting device is designed for a specific application. Alternatively, however, various types of load-bearing means can be attached, screwed or otherwise fastened to the support arm. For example, connectors can be provided which form a connection between the support arm and the load-bearing means. According to one embodiment, the connectors can be permanently provided on the support arm or fixed by detachable connecting means. The load-bearing means can then be coupled to the connectors. In a further embodiment, the connector can be connected to the load-bearing means or a plurality of connectors can be connected to the one load-bearing means, so that the load-bearing means can be attached to the support arm with the connectors. This enables a quick and easy conversion of the lifting device to different applications.

The load-bearing means can be provided, for example, in the form of a wheel fork. This wheel fork can be flat or can be driven over. This means that the lifting device can be freely accessible to the underbody of the vehicle. This is particularly advantageous for vehicles with an electric motor drive, as the batteries, which are positioned in the underbody between the front and rear axles, are freely accessible. In particular, if the battery needs to be changed, free accessibility is provided. The same applies to the design of the load-bearing means as a wheel-gripping element or as a so-called shelf, i.e. a wheel contact surface. Furthermore, the load-bearing means can be provided as a pivotable support arm, which can be attached to the support arm that is extendably arranged in the guide. This additional support arm portion can also be telescopic. Furthermore, a running rail can alternatively be coupled to the two opposite end portions of the support arms, so that this lifting device can also be converted to a running rail lifting platform.

Another alternative embodiment of the load-bearing means provides that said means has a support arm portion which is L-shaped and which is oriented in the horizontal plane relative to the support arm. According to a first embodiment, a portion of the L-shaped support arm portion may form the support arm itself. Furthermore, it may be provided that a leg of the L-shaped support arm portion is extendably received in the support arm. The other leg of the support arm portion may be fixed or telescopic. The L-shaped design of the support arm portion again provides good accessibility to the underbody of a vehicle.

Furthermore, the guide arranged on the support for receiving the at least one support arm is preferably oriented parallel to a direction of entry or exit of a vehicle into or from a working space. A working space is delimited in width by two lifting devices which are assigned to each other and are opposite each other. The length of the working space is determined by the end portions of the support arms extended in opposite directions and accommodated by the guide.

A further preferred embodiment of the lifting device provides that the base body and the support are formed as a lifting column. Thus, for example, two lifting columns opposite each other can form a lifting platform. These lifting columns may be permanently mounted on the ground. Alternatively, these lifting columns can also be moveable. In particular, in the latter case, a mobile wheel-gripping lifting platform can be created in which a plurality of lifting columns opposite each other in pairs can be combined depending on the number of axles of the vehicle to be lifted. Furthermore, the base body and the support can alternatively be designed as a lifting ram. Such lifting rams may be recessed in the ground. Furthermore, alternatively, the base body and the support may be in the form of a scissor arrangement, such as a double scissor, which in particular may also be recessed in the ground.

The object underlying the invention is further solved by a lifting platform for lifting vehicles or loads, in which two lifting devices arranged opposite each other in pairs or a plurality of lifting devices arranged opposite each other in pairs are provided according to one of the above embodiments and can be actuated by a common control. This provides a high degree of flexibility in the application.

The invention and other advantageous embodiments and refinements thereof are described and explained in more detail below with reference to the examples shown in the drawings. The features to be taken from the description and the drawings can be used individually or in any combination in accordance with the invention. The drawings show:

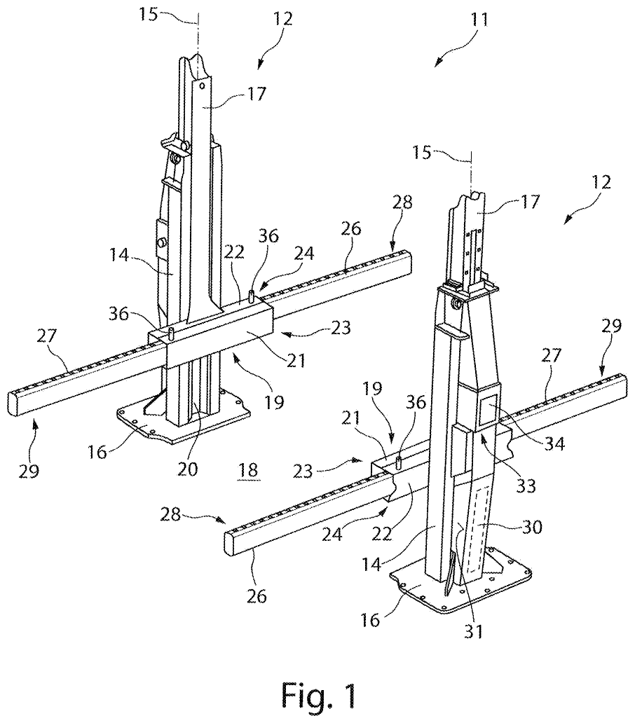

FIG. 1 a perspective view of a lifting platform with lifting devices,

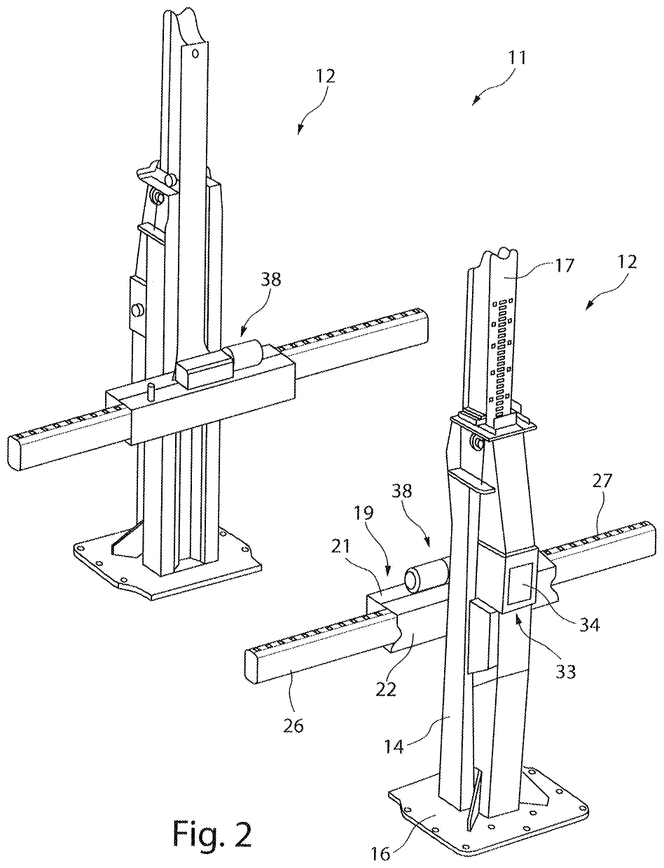

FIG. 2 a perspective view of an alternative embodiment of the lifting devices for a lifting platform according to FIG. 1,

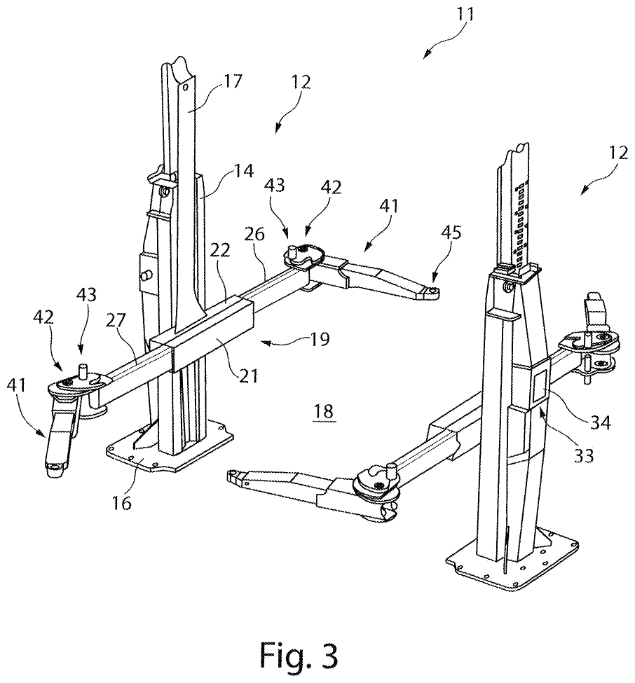

FIG. 3 a perspective view of the lifting platform according to a first embodiment,

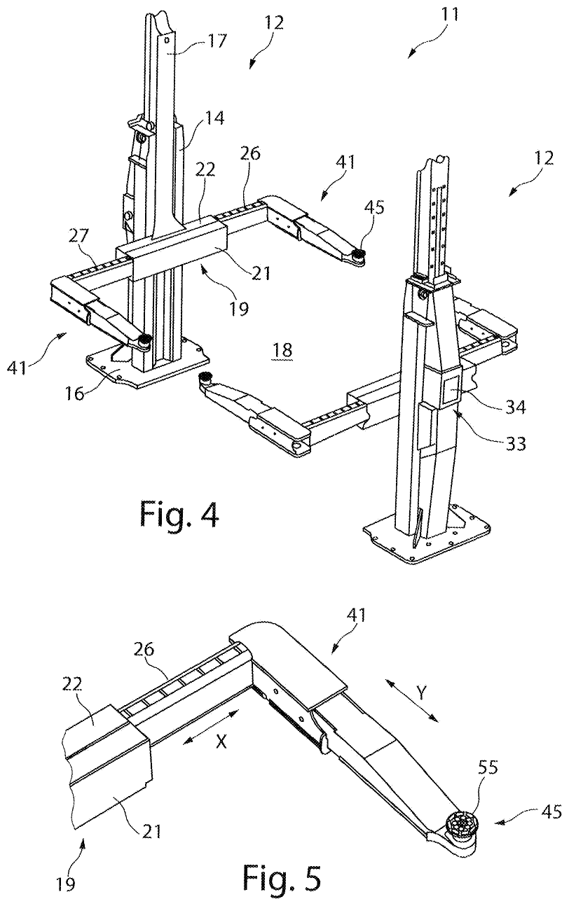

FIG. 4 a perspective view of the lifting platform in a further embodiment,

FIG. 5 a schematic enlarged view of a support arm portion of the lifting platform according to FIG. 4,

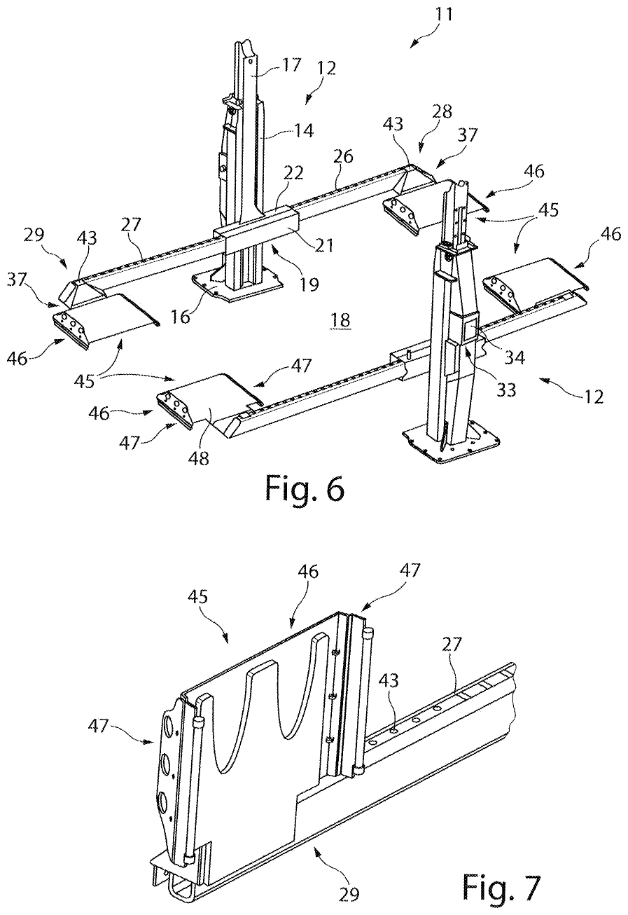

FIG. 6 a perspective view of the lifting platform in a further embodiment,

FIG. 7 a schematically enlarged view of a load-bearing means on the support arm according to FIG. 6,

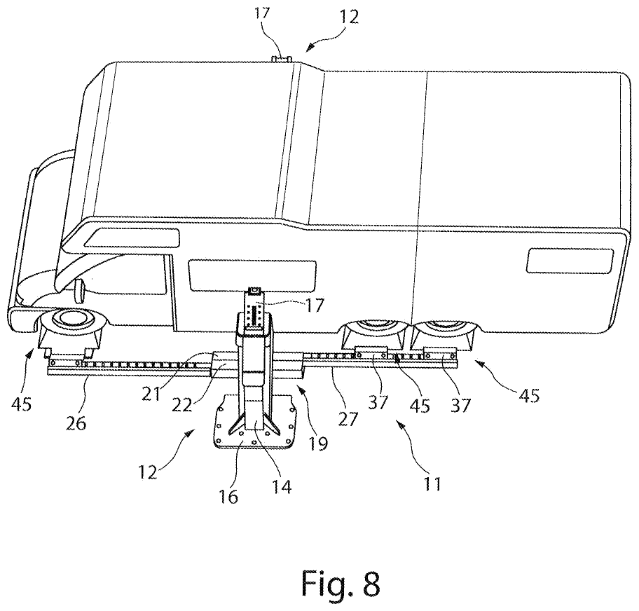

FIG. 8 a perspective view of an alternative embodiment of the lifting device to FIG. 6,

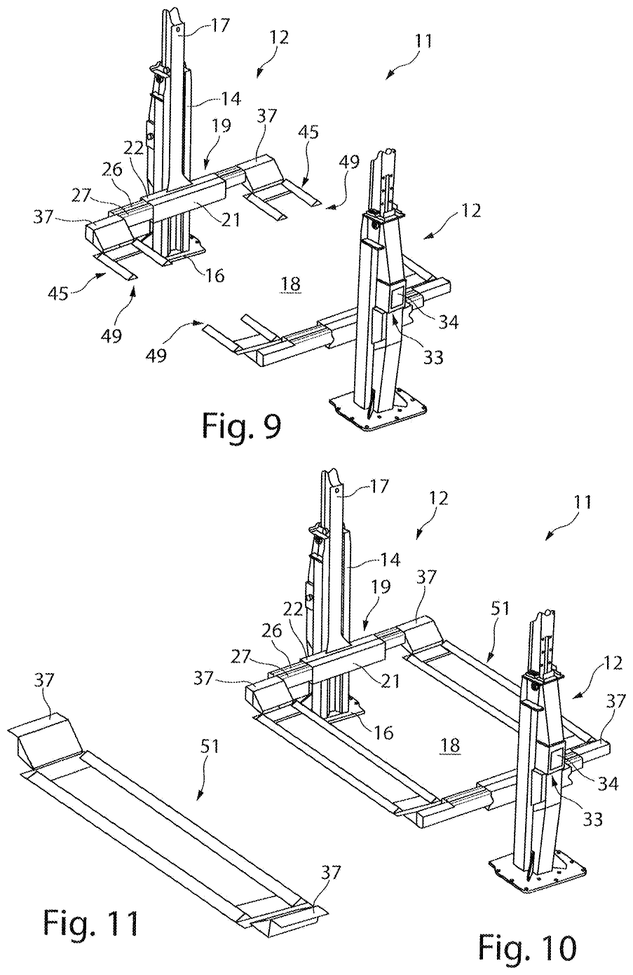

FIG. 9 a perspective view of the lifting platform in a further embodiment,

FIG. 10 a perspective view of the lifting platform in a further embodiment,

FIG. 11 a perspective view of a crosspiece for the embodiment according to FIG. 10,

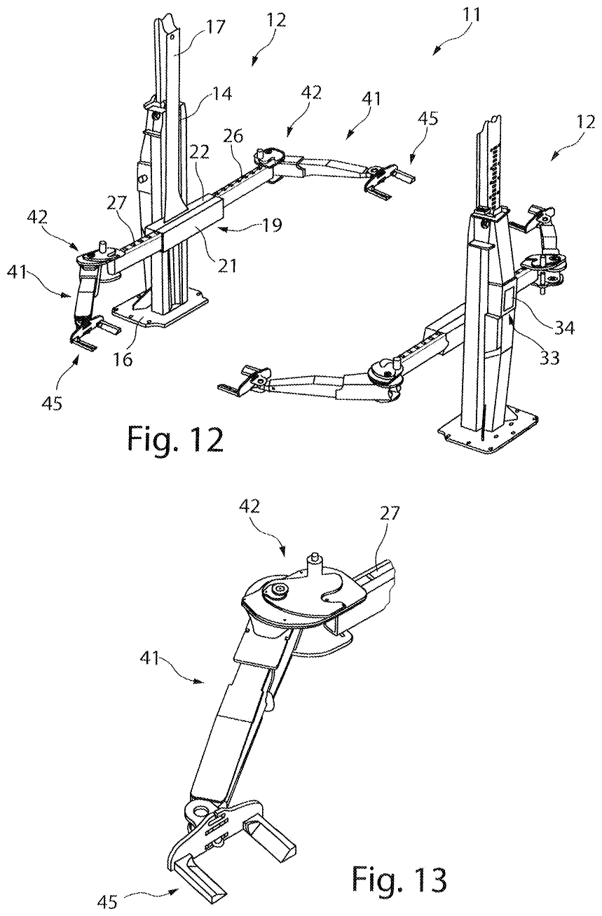

FIG. 12 a perspective view of the lifting platform in a further embodiment,

FIG. 13 a schematically enlarged view of a support arm portion according to FIG. 12,

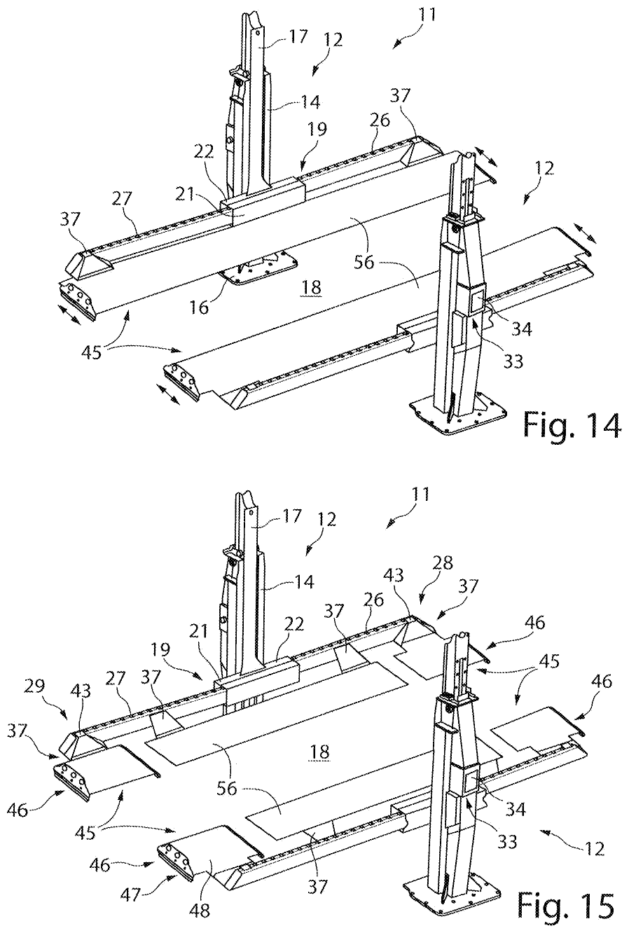

FIG. 14 a perspective view of the lifting platform in a further embodiment,

FIG. 15 a perspective view of the lifting platform in a further embodiment,

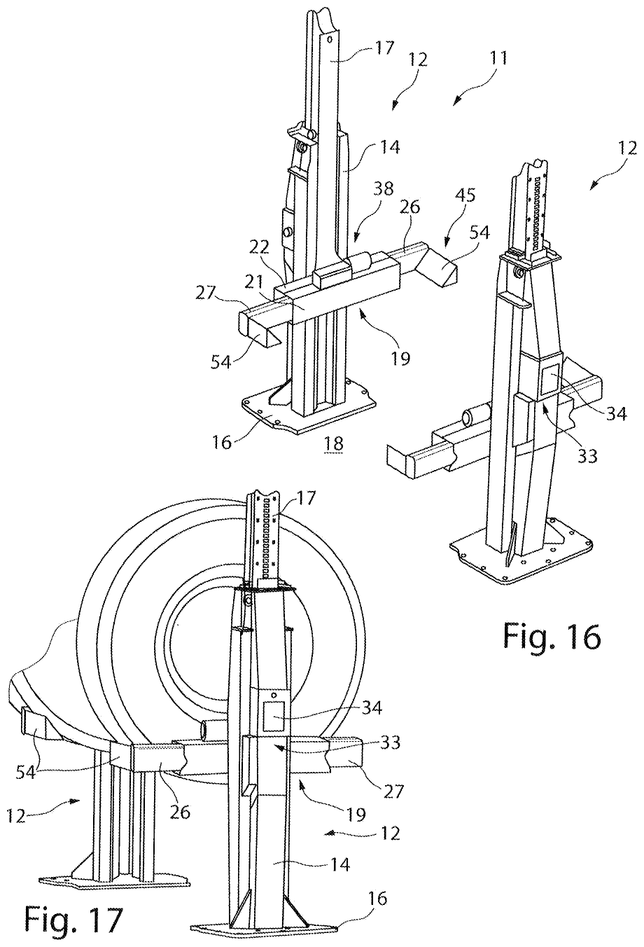

FIG. 16 a perspective view of the lifting platform in a further embodiment,

FIG. 17 a schematically enlarged view of the lifting platform according to FIG. 15 as a wheel gripper,

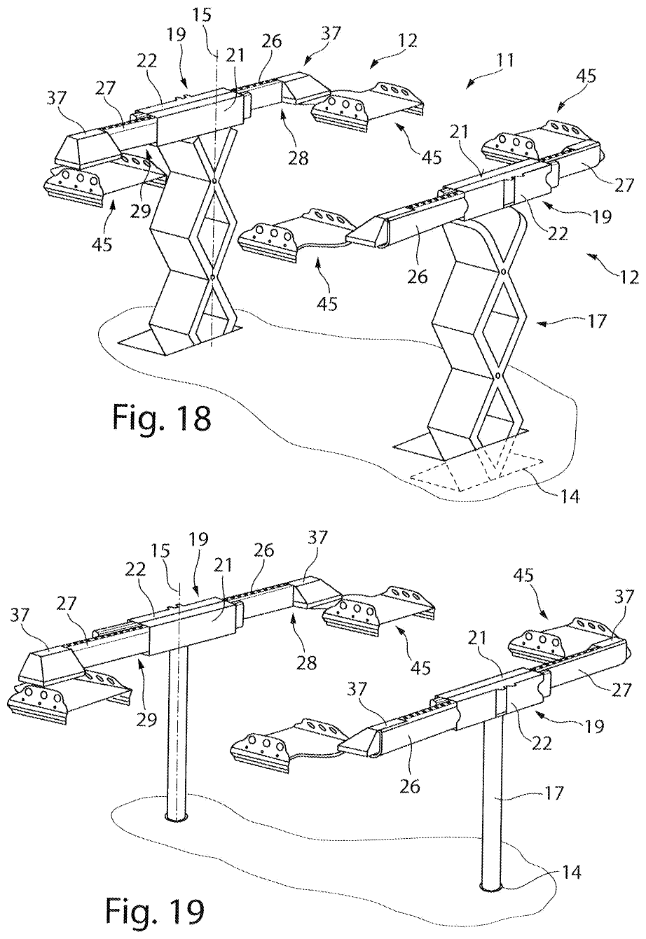

FIG. 18 a perspective view of an alternative embodiment of the lifting device to FIG. 1,

FIG. 19 a further perspective view of a further alternative embodiment to FIG. 1 and

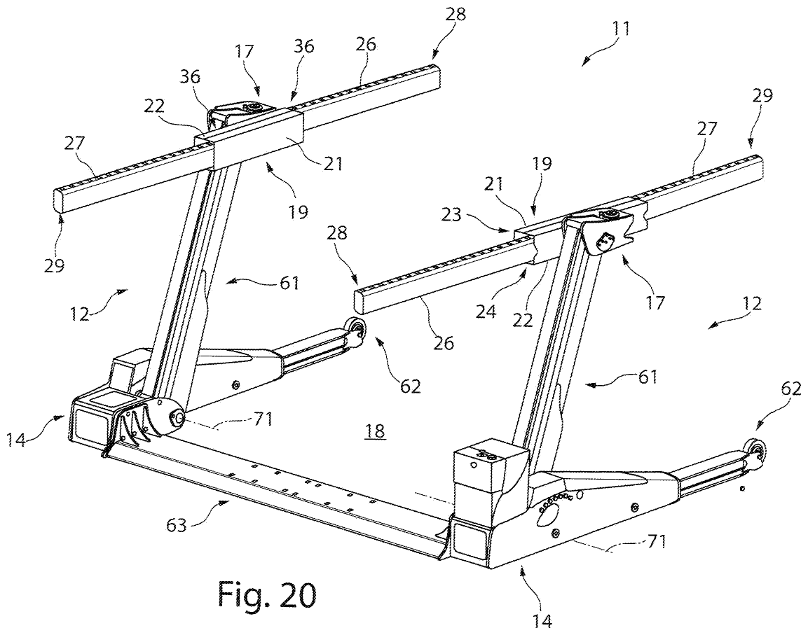

FIG. 20 a further perspective view of a further alternative embodiment to FIG. 1.

FIG. 1 shows a perspective view of a lifting platform 11. This lifting platform 11 comprises two lifting devices 12 which are assigned to each other. Each lifting device 12 is designed, for example, as a single-column lifting platform. The two lifting devices 12 arranged relative to each other form, for example, a two-column lifting platform.

The lifting device 12 comprises a base body 14, which in this embodiment is designed as a lifting column. The base body 14 is, for example, permanently connected to a foot plate 16, which is fixedly connected to a substrate surface. Alternatively, instead of the foot plate 16, a chassis can also be provided so that this lifting device 12 is mobile and can be moved to the desired installation location.

The base body 14 accommodates a support 17, which is provided so as to be moveable up and down along a stroke axis 15. A guide 19 is provided on the support 17 and is fixed to the support 17. This guide 19 can be formed in one part with the support 17. In this case, for example, a plug-in connection with a weld may be provided. Alternatively, the guide 19 can be detachably fixed to the support 17 via fastening elements. The guide 19 is arranged without pivoting movement in relation to the support 17.

The guide 19 comprises a first and a second hollow profile body 21, 22. These hollow profile bodies 21, 22 are provided adjacent to each other and in a horizontal plane. Preferably, the hollow profile bodies 21, 22 have the same length. Their end portions 23, 24 are preferably aligned with each other.

Preferably, each hollow profile body 21, 22 is rectangular in cross-section. Support arms 26, 27 are guided one in each of the hollow profile bodies 21, 22 so that said support arms can be extended or pulled out. This support arm 26, 27 is preferably also designed as hollow profile bodies 21, 22. The outer contour of each support arm 26, 27 preferably corresponds to an inner cross-section of the hollow profile body 21, 22. This can provide an anti-rotation means.

A sliding element, for example in the form of a plastic surface, or a guide element for reducing friction can be provided in the hollow profile body 21, 22 on at least two opposite side wall portions.

The support arms 26, 27 are shown in a maximally extended position in the exemplary embodiment according to FIG. 1. A predetermined length of an end portion of the support arm 26, 27 remains within the guide 19 so that sufficient load take-up or support is provided by the hollow profile bodies 21, 22.

A drive device 30 is provided on the base body 14 or the lifting column. This drive device can be electrohydraulic, hydraulic or mechanical. Preferably, the drive device 30, such as a hydraulic unit, is provided behind a cover 31 and preferably drives a lifting cylinder. The lifting cylinder 20 moves the support 17 up and down. The drive unit 30 is monitored and actuated by a control unit 33. For example, the control 33 can be operated via a display 34. It is also possible to operate the control 33 wirelessly via a remote control.

Furthermore, an accumulator, which is not shown in more detail, is provided on the base body 14 or the lifting column. Alternatively, in the case of a fixed connection of the lifting device 12, a cable-connected power supply can also be provided.

In the embodiment shown in FIG. 1, the support 17 is guided by the base body 14 and is moveable up and down. Alternatively, the support 17 can be sleeve-like or cartridge-like and can enclose the base body 14 or the lifting column. In this case, the components of the drive device 30 and the control 22 required to actuate the lifting device 12 are provided on the support 17.

The lifting devices 12 shown in FIG. 1 form a so-called basic module for a lifting platform 11, which can be used for a variety of applications, as shown in more detail in the following figures. Various load-bearing means 45 can be provided or arranged on the support arms 26, 27.

The support arms 26, 27 are preferably extendable or retractable independently of each other in their respective hollow profile bodies 21, 22. An extended position of the support arm 26, 27 or also a retracted position of the support arms 26, 27 in relation to the hollow profile body 21, 22 can preferably be secured by a releasable connecting element 36, such as a locking pin or the like. According to a first embodiment, the support arms 26, 27 are provided to be extendable or distendable manually and independently in the guide 19. In a retracted position of the support arms 26, 27, the opposite end portions 28, 29 may protrude on both sides with respect to the guide 19. This is shown for example in FIGS. 15 and 16.

The support arms 26, 27 shown in FIG. 1 are preferably formed in one piece from a hollow profile. Alternatively, the support arms 26, 27 can also be telescopic.

Furthermore, markings or a hole grid can be provided on the support arms 26, 27 in order to set a position relative to the guide 19 in a predetermined grid dimension. This can facilitate the conversion to different vehicles that have different wheelbases.

Furthermore, a running or support roller can preferably be provided at each end of the support arm 26, 27 and facing the ground. This can facilitate adjustment of the support arm 26, 27 or extension of the support arm 26, 27 relative to the guide 19 when it is lowered to the ground or substrate surface.

FIG. 2 shows an alternative design of the lifting devices 12 of the lifting platform 11 to FIG. 1. In this alternative design of the lifting devices 12, the extension and/or retraction movement of the support arms 26, 27 can be additionally controlled by at least one drive 38. This drive 38 can, for example, actuate both support arms 26, 27 simultaneously, so that the support arms 26, 27 can be moved synchronously with the guide 19. Alternatively, the drive 38 can also be designed in such a way that each of the support arms 26, 27 can be actuated independently of each other with regard to their travel position relative to the guide 19. The drive 38 can also actuate one of the two support arms 26, 27 and the second support arm 27, 26 can be moved in and out in a forcibly controlled manner via a gearing or a coupling mechanism or the like. The drive 38 is preferably controlled by an electric motor, in particular via the control 33. Preferably, the drive 38 is positioned on the guide 19 or on one or both hollow profile bodies 21, 22. This means that there is no encroachment on the installation space or with respect to a working space 18 between the two lifting devices 12. In addition, the support 17 can be fully lowered so that the guide 19 rests on the ground.

FIG. 3 shows the basic module of the lifting devices 12 according to FIG. 1 in a first application example or embodiment. In this embodiment, a support arm portion 41 is connected to the end portion 28, 29 of the support arms 26, 27 via a joint 42. This joint 42 may preferably be attached to the end portion 28, 29 of the support arm 26, 27 via a releasable connection 43. The support arm portion 41 can be telescopic according to the embodiment shown. At its free end, a receptacle is provided for positioning and attaching a load-bearing means 45. Alternatively, the support arm portion 41 can also have a fixed length. The support arm portion 41 preferably has a swivel range through the joint 42, which range comprises at least 90°. In a first swivel position, the support arm portion 41 is oriented parallel to the support arm 26, 27 and is preferably offset outwards relative to the working space 18. In a second pivot position, the support arm portion 41 may be oriented at right angles to the support arm 26, 27 and point into the working space 18. A further swivelling movement towards the guide 19 may also be possible.

In the lowered state of the support 17, the joint 42 preferably rests on the ground. In this case, the joint 42 can be unlocked in order to adjust the swivel position of the support arm portion 41. The length of a telescopic support arm portion 41 can also be adjustable. When the support 17 is lifted, the joint 42 is locked immediately after the housing 12 is lifted off the ground, so that the support arm portion 41 is secured against turning relative to the support arm 26, 27.

FIG. 4 shows another alternative embodiment of the lifting devices 12 to FIG. 1. In this embodiment, the support arm portion 41 is permanently connected, in particular welded, to the end portion 28, 29 of the support arms 26, 27. This is shown enlarged in FIG. 5. The support arm portion 41 can preferably be telescopic. For example, a turntable 55, which is height-adjustable, is provided as a load-bearing means 45. The support arm portion 41 is oriented and positioned at right angles to the support arm 26, 27. Alternatively, the support arm portion 41 may be formed as an L-shaped leg, wherein an L-shaped leg is insertable into the support arm 26, 27 and is variable in distance from the end portion 28, 29 of the support arm 26, 27 and is preferably lockable. Furthermore, the support arm portion 41 can alternatively be designed as a fork tine. The support arm portion 41 and the load-bearing means 45 are formed in one part.

FIG. 6 shows another alternative embodiment of the lifting devices 12 to FIG. 1. In this embodiment, load-bearing means 45 in the form of shelves 46 are provided on the support arm 26, 27. These shelves 46 have an upward and downward travel region 47 and a support region 48 in between. In the lowered state of the lifting platform 11, the shelves 46 rest on the ground and the upward and downward regions 47 form a slope so that a vehicle can be easily driven into the working space 18 and the wheels are positioned on the support region 48 of the shelves 46. In this embodiment, as in the previously described embodiments, it is also possible that complete accessibility to the underbody region of the vehicle is possible. In particular, free accessibility to batteries of electric vehicles is provided.

FIG. 7 shows an advantageous embodiment of the load-bearing means 45 in the form of a shelf. These can be able to be folded up, for example, so that it is not necessary to drive over the load-bearing means 45 when guiding the vehicle into and out of the working space 18. Furthermore, the load-bearing means 45 can be longitudinally displaceable transversely to the direction of entry and exit. The load-bearing means 45 arranged on each lifting device 12 and facing each other can thus be moved towards each other. This has the advantage that vehicles with a smaller wheelbase can also be received.

The load-bearing means 45 shown in FIGS. 6 and 7 can also be arranged height-adjustably on the support arm 26, 27. Especially when using the lifting platform 11 for wheel alignment, it may be necessary to compensate for tolerances in the lifting devices 12 in order to level the height of the support regions 48 in relation to each other.

Furthermore, the lifting device 12 as shown in FIG. 6 can be modified in such a way that hold-down means are positioned on the support region 48 in order to hold down the upward and downward region 47. These hold-down means also have a support surface which is intended to rest against and engage with the sill of a vehicle. As a result, this embodiment of the lifting devices 12 shown in FIG. 6 can be used to lift vehicles with the wheels freely raised from the ground.

FIG. 8 shows a further embodiment of the lifting platform 11 shown in FIG. 6. The lifting device 12 can be used not only for two-axle vehicles, but also for multi-axle vehicles. FIG. 8 shows, for example, a three-axle vehicle. One or more load-bearing means 45 can be used or arranged on the support arms 26, 27 in accordance with the number and/or spacing of the axles. In the exemplary embodiment, only one load-bearing means 45 is provided on the support arm 26 and two load-bearing means 45 are provided adjacently to each other on the other support arm 27. In the case of such vehicles to be lifted, the load distribution may also deviate from the centre of the vehicle. In these cases, the support arms 26, 27 can be extended asymmetrically to the guide 19 so that the central load is located in or near the lifting axles 15 of the lifting devices 12.

FIG. 9 shows another embodiment of the lifting devices 12. In this embodiment, the load-bearing means 45 are designed as wheel forks 49 that can be driven over. These wheel forks 49 that can be driven over have the advantage that no extra anti-roll-off devices are required.

These load-bearing means 45 can be suspended and positioned on the support arm 26, 27 or fixed with a detachable connecting element 36.

FIG. 10 shows another alternative embodiment of the lifting devices 12. In this embodiment, a load-bearing means 45 in the form of a crosspiece 51 extends between two opposing lifting devices 12. Such a crosspiece 51 is shown in FIG. 11. Connectors 37 are provided at the relevant end of the crosspiece 51, by means of which the crosspiece 51 can be securely connected to an opposite support arm 26, 27 of the lifting devices 12, preferably by means of a detachable connection.

FIG. 12 shows another alternative embodiment of the lifting device 12. Support arm portions 41 can be provided on the support arms 26, 27 via the joint 42, which are shown enlarged in FIG. 13. The load-bearing means 45 are preferably designed as flat wheel forks 49.

FIG. 14 shows another alternative embodiment of the lifting device. In this embodiment, the support arms 26, 27 are extended in relation to the guide 19. A load-bearing means 45 in the form of a running rail 56 engages on the support arms 26, 27. Preferably, the connections 37 are again provided for this purpose, which are secured to the support arms 26, 27 with a detachable connection 43. The connections 37 and the respective rails 56 are mounted so that they can be moved relative to each other. This means that the distance between the rails 56 can be adjusted to different track widths. Thus, the basic module of the lifting device 12 according to FIG. 1 can be designed or modified as a running rail lifting platform.

FIG. 15 shows an alternative embodiment of the lifting device 12 to the embodiments described above. In this embodiment, a plurality of load-bearing elements 45 are provided in a row on respective lifting devices 12. For example, the load-bearing element 45 shown in FIGS. 6 and 7 may be provided in each case at an outer end portion 28, 29 of the support arms 26, 27. A running rail 56 can be arranged in between as a load-bearing means 54. Alternatively or in addition to the running rails, a plurality of shelves 46 can be provided as load-bearing means 45. The distances between the load-bearing means 45 arranged in a row are so small that when a vehicle drives onto the load-bearing means 45, the distances between the individual load-bearing means 45 can be driven over. Alternatively, these load-bearing means 45 can also be provided in close proximity to one another on the lifting device 12. Instead of the load-bearing means 45 shown in FIG. 15 as shelves 46 at the various end portions 28, 29 of the support arms 26, 27, further load-bearing means 45 can also be provided in accordance with one of the embodiments described above or combined with one another.

FIG. 16 shows a perspective view of another alternative embodiment of the lifting device 12. In this embodiment, a wheel-gripping element 54 is provided on each of the support arms 26, 27. If the support arms 26, 27 are oriented at a predetermined distance from each other, the two wheel-gripping elements 54 form a load-bearing means 45, which is designed as a wheel gripper. This application is shown schematically in FIG. 17. This arrangement makes it possible to receive vehicle tyres of different diameters. In particular, special vehicles with oversized wheels can be lifted.

FIG. 18 shows a perspective view of an alternative embodiment of the lifting device 12. In this embodiment of the lifting device 12, the support 17 is in the form of a double scissor arrangement to which the guide 19 is attached. The base body 14 is formed as a base plate or base attachment. This support 17 is shown in a lifted or extended position. In a lowered position of the lifting device 12, the guide 19 as well as the support arms 26, 27 or the load-bearing means 45 arranged thereon preferably rest on the ground. The base body 14 is preferably recessed in the ground.

FIG. 19 shows another alternative embodiment of the lifting device 12 to FIG. 18. In this embodiment, the support 17 is designed as an extendable lifting ram and the base body 14 as a lifting ram housing. This arrangement shown in FIG. 18 is a so-called ram platform. At the upper end of the support 17 the guide 19 is mounted for receiving the at least one support arm 26, 27. In the lowered state of the lifting device 12, at least the load-bearing means 45 rest on the ground.

The above embodiments of the lifting devices 12 show that, starting from a basic module of the lifting device 12 according to FIG. 1, a two-column lifting platform or a multi-column lifting platform can be converted in a simple and quick manner to different applications and/or embodiments. One or more load-bearing means 45 may be provided on the support arm or arms 26, 27, the number of load-bearing means 45 per support arm 26, 26 being the same, but could also possibly differ from one another. Alternatively or additionally, load-bearing means 45 of identical construction can be arranged on the support arm(s) 26, 27. Load-bearing means 45 differing from each other can also be provided on the same support arm 26, 27 or on the support arms 26, 27. In addition, very large and long vehicles can also be received along the sill.

FIG. 20 shows another alternative embodiment of a lifting device 12. In this embodiment, it is provided that the support 17 is guided so as to be moveable up and down with respect to the base body 14 by a pivoting movement around a pivot axis 71, which is located in the base body 14. For example, a parallelogram guide 61 is provided between the support 17 and the base body 14. As a result, the support 17 is moved up and down in the base body 14 by a pivoting movement around the pivot axis 71, and at the same time the support 17 remains oriented in the horizontal direction. The base body 14 is formed as a housing resting flat on the ground, in which a lifting cylinder or drive is provided to actuate the up and down movement of the support 17. A roller 62 may further be provided at one end of the base body 14. The opposing lifting devices 12 are connected to each other by a common central part 63. A drawbar can be attached to the centre part 63 so that the entire lifting platform 11 can be moved to the installation site via the castors 62 of the respective base bodies 14 and the moveable drawbar. In the embodiment shown in FIG. 20, the drawbar is removed from the centre part 63 and the lifting platform 11 rests on a base.

The guide 19 is fixed to the support 17 of the lifting device 12. All the embodiments described above with regard to the connection of the guide 19 to the support 17 also apply to the present embodiment according to FIG. 20. Likewise, all the embodiments described above with regard to the design of the guide 19 and the at least one support arm 26, 27, on which at least one load-bearing means 45 is provided or can be attached, can also be referred to in full for this embodiment according to FIG. 20.

1. A lifting device for lifting and lowering vehicles or loads,
with a base body and with a support moveable up and down relative to the base body,
with a drive device for lifting and lowering the support, wherein
a guide is provided on the support, which guide is permanently connected to the support, and
the guide has at least one support arm which is mounted on the guide so as to be extendable at least on one side in the horizontal direction through the guide.

2. The lifting device according to claim 1, wherein the at least one support arm is mounted in the guide and the guide has at least one hollow profile body in which the at least one support arm is guided.

3. The lifting device according to claim 2, wherein the at least one support arm and the at least one hollow profile body have geometries which are matched to one another and which forms an anti-rotation means for the at least one support arm.

4. The lifting device according to claim 1, wherein the at least one support arm is secured in position relative to the guide by a releasable connecting element.

5. The lifting device according to claim 1, wherein the guide accommodates two support arms which are arranged adjacently to one another and which are provided separately from one another in each case in a hollow profile body of the guide.

6. The lifting device according to claim 1, wherein the guide has a hollow profile body in which two support arms are mounted so as to be extendable, the support arms being mounted in a line one behind the other or in a manner engaging in one another or in parallel side by side in the hollow profile body.

7. The lifting device according to claim 1, wherein the support arms are mounted in the guide so as to be extendable in opposite directions to one another.

8. The lifting device according to claim 1, wherein the support arms are extendably synchronously or independently of each other.

9. The lifting device according to claim 1, wherein the length of each hollow body profile for forming the guide is equal and/or their end portions are aligned with each other.

10. The lifting device according to claim 1, wherein a drive is provided on the guide and actuates a traversing movement of the at least one support arm.

11. The lifting device according to claim 11, wherein the support arms are movable individually by the drive, or in that one support arm is actuatable so as to be moveable by the drive and the other support arm is movable in a forcibly controlled manner.

12. The lifting device according to claim 1, wherein at least one load-bearing means is provided or is arrangable on the support arm, or on an extendable end portion of the support arm.

13. The lifting device according to claim 13, wherein the at least one load-bearing means is permanently connected or provided with a releasable connection to the support arm or directly couplable thereto, or in that at least one connector is permanently arranged on or couplable to the support arm and the at least one load-bearing means is permanently connected or couplable to the at least one connector.

14. The lifting device according to claim 13, wherein the load-bearing means is formed as a shelf, a wheel fork, a wheel-gripping element, a turntable or a pivotable support arm portion or a telescopic support arm portion or a running rail.

15. The lifting device according to claim 13, wherein the load-bearing means is formed as a support arm portion oriented at right angles to the support arm or as an L-shaped support arm portion oriented in the horizontal plane.

16. The lifting device according to claim 1, wherein the guide provided fixedly on the support is oriented parallel to a direction of entry or exit of a vehicle into or from a working space.

17. The lifting device according to claim 1, wherein the support is guided along a stroke axis so as to be moveable up and down in the vertical direction through the base body.

18. The lifting device according to claim 1, wherein the support is guided so as to be moveable up and down around a pivot axis of the base body or the support is guided so as to be moveable up and down around the pivot axis on the base body by a parallelogram guide.

19. The lifting platform for lifting and lowering vehicles or loads, wherein two lifting devices arranged opposite one another in pairs or a plurality of lifting devices arranged opposite one another in pairs according to claim 1 are provided and are actuatable by a common control.

20. The lifting device according to claim 1, wherein the guide is formed by two hollow profile bodies lying in one plane.
